(19) United States
(12) Patent Application Publication
(10) Pub. No.: US 2012/0095670 A1
(43) Pub. Date: Apr. 19, 2012

(54) INTELLIGENT ENGINE IDLE STOP LOGIC

(75) Inventor: Alfred Piggott, Redford, MI (US)

(73) Assignee: DENSO INTERNATIONAL AMERICA, INC., Southfield, MI (US)

(21) Appl. No.: 12/903,728

(22) Filed: Oct. 13, 2010

(51) Int. Cl. F02D 17/04

(52) U.S. Cl. 701/112; 701/113

(57) ABSTRACT

A method of controlling an internal combustion engine of a vehicle may involve turning on the internal combustion engine, stopping the vehicle or while the vehicle is approaching a known potential stopping location, inquiring whether a first predetermined quantity of data samples exists in memory and further inquiring whether the first predetermined quantity of data samples corresponds to a specific time of day, of a specific day of the week, of a specific month of the year, for a specific GPS location, inquiring whether a second predetermined quantity of data samples exists in memory for the specific time of any day of the week for the specific GPS location, inquiring whether a third predetermined quantity of data samples exists for any single, specific time of day for any day of the week for the specific GPS location. Depending upon the reply to each of the above inquiries, the method may include turning off the internal combustion engine.

### FIELD

The present disclosure relates to a method of controlling and engine of a vehicle equipped with engine idle stop or idle start-stop technology.

### BACKGROUND

This section provides background information related to the present disclosure which is not necessarily prior art. Select present day vehicles may be equipped with engine idle stop (“EIS”) technology, which is also known as idle start-stop (“ISS”) technology. An ISS system may be configured to stop an engine of a vehicle during time periods of non-useful engine idle. Time periods of non-useful engine idle may be experienced when a vehicle stops in traffic and the vehicle's engine idles until the vehicle once again moves, or when a vehicle is stopped at a stop sign, stopped in traffic, stopped at a drive-through window, or at a railroad crossing. Other time periods of non-useful engine idle may exist. However, such present day ISS systems are not without their share of limitations. For instance, some ISS systems may stop a vehicle engine based only on a status of a combination of vehicle parameters or events. Such parameters may include when a brake pedal is pushed, when an accelerator pedal is not being pushed, when a battery of a vehicle is charged a prescribed degree, when a temperature of discharge air of an air conditioning system is satisfactory, and when vehicle speed is zero. The limitation of such ISS systems is that they do not take into consideration a “fuel penalty” required to restart the vehicle engine after the engine has been stopped. The additional fuel required to restart the vehicle after it has been stopped, as opposed to letting the engine idle for the amount of time that the engine was actually stopped, may be an amount of fuel equal or exceeding that amount of fuel combusted during an engine running time range of 10-20 seconds. Moreover, electrical energy may be wasted during restarting an engine since an engine starter consumes electrical energy to restart the engine. The electrical energy consumed during restarting will be restored by a vehicle charging system using electrical energy generated through fuel combustion.

What is needed then is a method of controlling an engine idle start-stop (“ISS”) system that determines whether an engine should be turned off and then restarted, or remain on, in order to maximize fuel efficiency.

### SUMMARY

This section provides a general summary of the disclosure, and is not a comprehensive disclosure of its full scope or all of its features. A method of controlling an internal combustion engine of a vehicle may entail turning on the internal combustion engine, determining that a brake pedal of the vehicle is applied, determining that an accelerator pedal of the vehicle is not applied, determining that a drive battery or batteries of the vehicle are adequately charged, determining that an air temperature of air coming from an air conditioning unit is within a predetermined range, determining that a humidity level of air coming from an air conditioning unit is within a predetermined range, and inquiring whether a first predetermined quantity of data samples exists in memory that correspond to a specific time of day, of a specific day of the week, of a specific month of the year, for a specific GPS location. Such data samples may pertain to a specific turn signal direction for a specific time of day, for a specific day of the week, for a specific month of the year, for a specific GPS location.

Moreover, the method of controlling an internal combustion engine may further entail inquiring whether a second predetermined quantity of data samples exists in memory for a specific time of day of any day of the week for a specific GPS location. The method of controlling an internal combustion engine may further entail inquiring whether a third predetermined quantity of data samples exists for any single, specific time of day for any day of the week for a specific GPS location. The method of controlling an internal combustion engine may further entail inquiring whether a fourth predetermined quantity of data samples exists as downloadable data from a real time wireless network, as opposed or in addition to data that resident in on-board, vehicle memory. Depending upon the result of the above inquiries, the method of controlling an internal combustion engine may entail turning off the internal combustion engine.

The method of controlling an internal combustion engine may entail inquiring if a probability of a physical stop of the vehicle is greater than a predetermined probability, then calculating a median stop time value, and then inquiring whether a time to a median vehicle stop position plus a median stop time is greater than the idle restart penalty of the internal combustion engine.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle depicting the location of an engine and engine control module in accordance with the present teachings;

FIG. 2 is an interior perspective view of the vehicle depicting a location of the engine control module, a display screen, an a GPS receiver;

FIG. 3 is a distribution of vehicle stops versus stop time for a vehicle or vehicles;

FIG. 4 is a graph of fuel consumed versus time for a vehicle employing the present teachings and a vehicle not employing the present teachings;

FIG. 5 is a graph of data confidence versus vehicle stops for a given vehicle;

FIG. 6 is a graph of overlapping distributions of number of stops for a given vehicle or vehicles versus length of time stopped for such vehicle;

FIG. 7 is a graph of different distributions of number of stops for a given vehicle or vehicles versus length of time stopped for such vehicle; and

FIG. 8 is a flowchart of control logic for controlling an idle start-stop (“ISS”) system of a vehicle.

Corresponding reference numerals indicate corresponding parts throughout the several views of the drawings.

### DETAILED DESCRIPTION

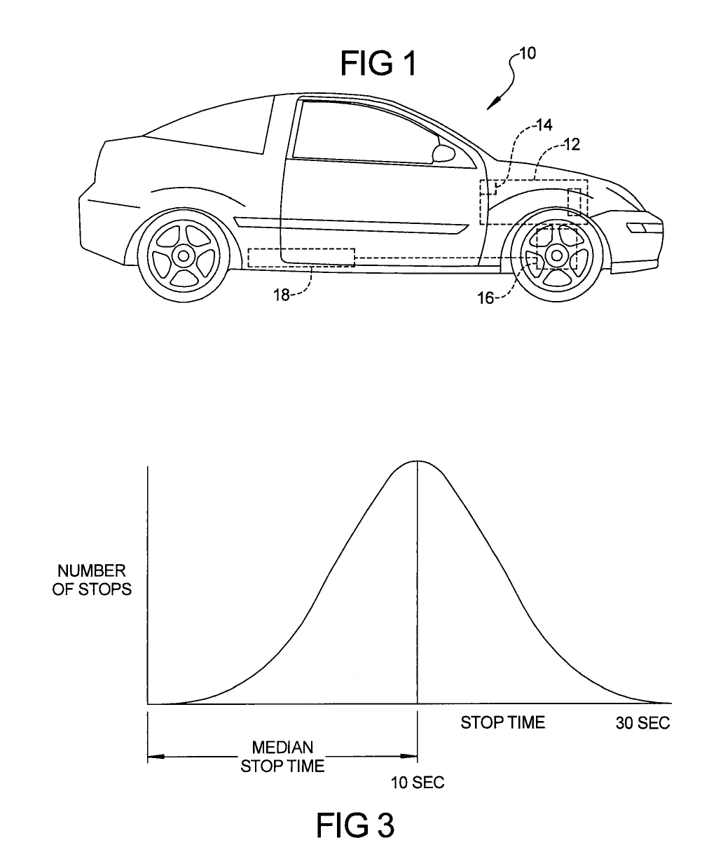

Example embodiments will now be described more fully with reference to FIGS. 1-8 of the accompanying drawings. FIG. 1 depicts a vehicle 10 equipped with an internal combustion engine 12 and an engine control module 14 and an electric motor. Vehicle 10 may be a hybrid vehicle or a non-hybrid vehicle. That is, vehicle 10 may be powered only by engine 12, or vehicle 10 may be powered by either engine 12 or electric motor 16, which receives electrical energy from a battery or battery pack 18, which may or may not be located under a hood or in an engine compartment of vehicle 10. One or more electric motors may be employed, such as one electric motor at each wheel of vehicle 10.

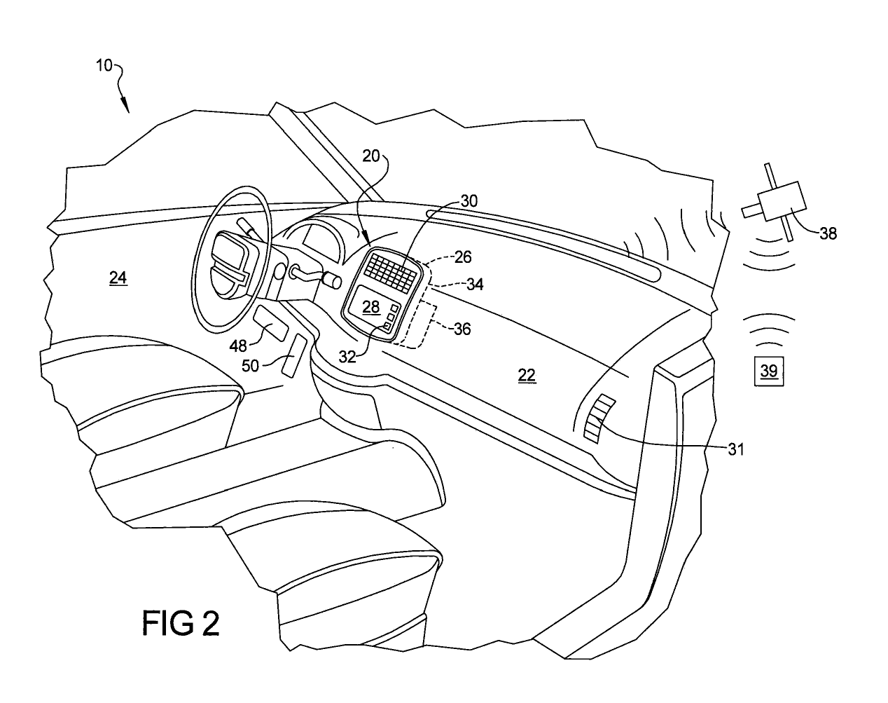

FIG. 2 depicts a navigation system 20, which may be mounted in or behind a dash 22 of an interior compartment 24 of vehicle 10. Navigation system 20 may employ a navigation control unit 26 that computes route data, such as a route that vehicle 10 is traveling or is recommended to travel, and displays such route data on a navigation system display 28. The navigation control unit 26 may determine positions of vehicle 10 relative to a destination address that may be entered into the navigation system using physical buttons 30 or a touch screen feature of the display 28 of navigation system 20 to provide visual driving directions on display 28 and audible driving directions to explain to the driver how to successfully navigate to the destination address. The navigation control unit 26 may also include a memory 34 with a feature that permits the driver of vehicle 10 to store frequently used destination addresses such as a home addresses, business addresses, or work addresses. These stored addresses may be temporarily viewable on display 28 when accessing or using the memory feature. Memory features and programming features of navigation system 20 may be accessed using one or more buttons 30 on the dash or as part of touch screen 32 such as around a periphery of display 28. The navigation control unit 26 may cooperate with a Global Positioning System (GPS) module 36, which in turn may bilaterally communicate with a GPS satellite 38 to display a location of vehicle 10 on display 28. GPS module 36 determines a location of the vehicle 10 according to data received from the GPS satellite 38. Engine control module 14 (“ECM”) may also communicate with memory 34 and display 28, as will be further explained below.

FIG. 3 depicts a distribution 40 of vehicle stops versus length of stop time for a vehicle. More specifically, distribution 40 may represent a plot of the number of stops that a vehicle makes at a specific location and the length of the time stopped for each stop. As an example, the specific location may be a location of a particular, specific stop sign in a high traffic area, such as at a four-way stop, for example. Such a stop may last more or less than 30 seconds, for example, as noted in FIG. 3. Moreover, at the particular stop sign, vehicle 10 may make a left turn on a regular basis. Such a stop, left turn, and length of stop may all be recorded in memory 34 since use and non-use of a vehicle brake, vehicle left and right turn signals and vehicle accelerator may all be tracked or recorded by ECM 14 prior to being stored in memory 34. In turn, ECM 14 may be linked to memory 34. More specifically, as a driver of vehicle 10 approaches such a stop sign, the intersection may be detected by the GPS module 36 in vehicle 10. Such a detection may activate a computer, resident in GPS module 36 or ECM 14, to check the probability of a stop and check the on-board “stop time” memory, which may be part of memory 34. In this example utilizing a stop sign, the memory 34 may communicate with the computer resident in GPS module 36, which may return a probability of 100%, since a driver must stop at all stop signs. Additionally, GPS module 36 may also record the time of day and that a left turn is being indicated by a left turn signal of vehicle 10. The GPS module 36 may also determine from memory 34 that the median stop time of vehicle 10 at the particular stop sign, is 10 seconds, as depicted in FIG. 3. For engine 12, and knowledge of the median, or average wait time at this particular stop time, based upon its GPS location, the computer may determine that stopping engine 12 for only 10 seconds, will result in more fuel being consumed by engine 12 than if the engine remains running for 10 seconds. Such may be the case because of the particular engine employed and the volume or quantity of fuel that it requires to be restarted. That is, generally engine 12 may consume the same amount of fuel or more during restarting than if engine 12 were permitted to operate, and not be turned off in an idle-stop event.

Data collected in the above-described scenario may be set to expire or be deleted from memory at prescribed or predetermined time periods from when it is collected. Alternatively, data may be deleted from memory at particular dates, such as monthly, annually, etc. in an automatic fashion, without human intervention to directly cause such deletion absent some initial set up or programming of when data should be deleted. Predetermined time periods may be set by the user of a vehicle based upon a general comfort level with using data of a certain age. Older data may reduce the accuracy or usefulness of the idle-stop logic if driving habits evident with a certain vehicle change over time. In other instances, the age of data will not affect proper or desired operation of the idle-stop logic.

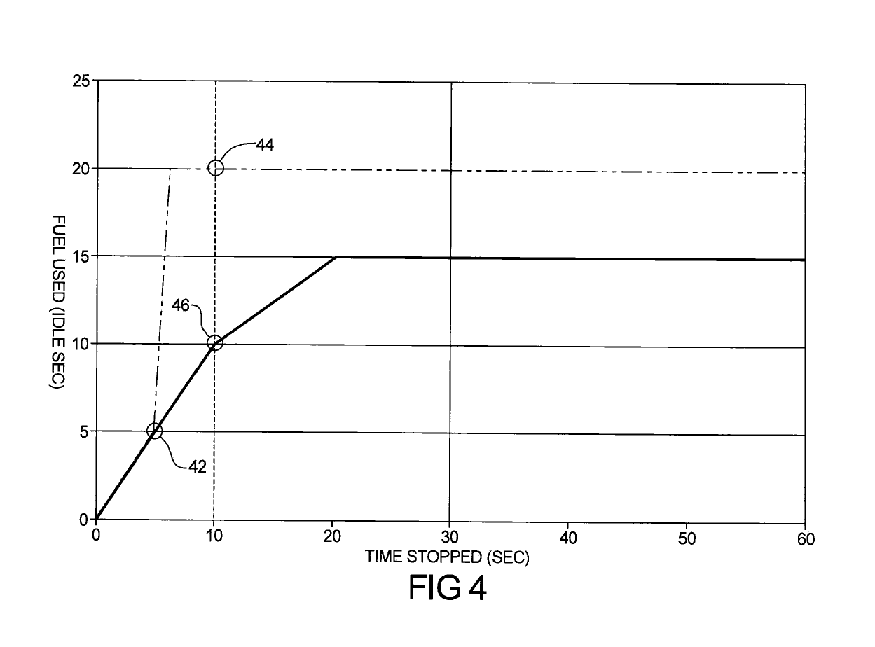

Turning now to FIG. 4, fuel consumption of a vehicle equipped with idle-stop logic of the present disclosure, depicted with a solid line in FIG. 4, will be compared to a vehicle not equipped with idle-stop logic, depicted with a dashed line in FIG. 4. FIG. 4 depicts locations 42, 44 and 46 that represent fuel consumption volumes equated to or converted to an idle time fuel consumption for a vehicle engine of a vehicle. Idle time fuel consumption is a volume of fuel that is consumed for a given time period of engine idling. In a first example, a vehicle may approach a stop sign and stop at a stop sign for 5 seconds and then immediately turn off its engine. This may place the vehicle at location 42 on FIG. 5. In accordance with the dashed line for a vehicle not equipped with idle-stop logic of the present disclosure, no other information, such as external information, is available to the vehicle, by way of memory, GPS, etc. concerning the stop location. If the driver immediately drives away from the stop location after the 5 second stop, the vehicle engine may immediately restart so that the vehicle may move. However, every vehicle engine has a restart penalty associated with it and thus every vehicle engine restart penalty may equal an amount of fuel burned during restarting that may be equated to a length of engine idle time. Location 44 depicts the 5 seconds of fuel burned from the time that a vehicle is initially stopped until the engine is turned off, plus 5 additional seconds to restart, thus totaling 10 seconds of total stop time. However, a 15 second “fuel penalty” exists for the engine of the vehicle every time the engine is started. Thus, even though only 10 seconds have actually elapsed, 20 seconds of fuel have been consumed, assuming that all fuel is consumed at idle speed of the vehicle engine (i.e. equated to fuel consumption for idling in terms of time). Thus, 20 seconds of fuel have been consumed to stop and immediately restart the vehicle, if that amount of fuel is equated to an idle volume. That is, no waiting at the stop sign was experienced and the vehicle was immediately restarted as soon as the vehicle stopped moving and the engine was stopped because the driver desired again to move the vehicle. Thus, location 44 of FIG. 4 depicts 10 seconds of actual elapsed time and 15 seconds worth of fuel burned due to the restart penalty (the fuel burned is equated to fuel burned during an idling). That is, restarting the engine consumes more fuel than if the engine was left to merely idle during the same time period of restarting. Thus, the fuel consumption for the restarting time period can be equated to a fuel consumption of an idle time period, as noted with the dashed line in FIG. 4, which leads to location 44.

The solid line of FIG. 4 that leads to location 46 denotes fuel consumed for a vehicle equipped with idle-stop logic of the present disclosure. Such a vehicle utilizes the same engine as used in the consumption scenario discussed in conjunction with the dashed line. However, from location 42 to location 46, vehicle 10 that is equipped with the teachings of the present disclosure minimizes fuel burned when compared to the dashed line running from location 42 to location 44. Assuming vehicle 10 approaches the same stop sign at a location that is known by the memory 34 of GPS module 36, engine 12 of vehicle 10 may not be turned off immediately after stopping at the stop sign. That is, the on board computer knows not to turn off the engine 12 of vehicle 10 at the stop sign because the computer knows from memory 34 that the median stop time at the stop sign is 10 seconds. Thus, by calculation, the computer determines a 10 second idle stop will use more fuel to restart the engine than it will save with a 10 second stop idle. Thus, if the vehicle stops at the stop sign for 5 seconds, then turns its engine off and then restarts, a 15 second restart penalty results, totaling 20 seconds of total fuel burned during the stop. However, if vehicle 10 utilizes GPS module 36 and memory 34 and determines the location of vehicle 10 using GPS satellite 38 as vehicle 10 approaches the stop sign discussed in conjunction with the scenarios of FIG. 4, GPS module 36 may communicate with ECM 14 and know not to turn off engine 12 when vehicle 10 approaches the stop sign, because the stop at this particular stop sign is known to have a median stop time of 10 seconds. Thus, only 10 seconds of fuel is burned during a 10 second vehicle stop.

In still yet another scenario, assuming vehicle 10 approaches the same stop sign at a location that is known by the memory 34 of GPS module 36, engine 12 of vehicle 10 may be turned off as vehicle 10 is approaching the stop sign but before vehicle 10 actually stops at the stop sign. That is, an on board computer knows how much time the vehicle takes to move from a predetermined GPS location before the stop sign until the vehicle reaches the stop sign. Thus, the on board computer may turn off the engine 12 of vehicle 10 before vehicle 10 reaches the stop sign to conserve fuel on the vehicle's approach to the stop sign. Moreover, fuel may be conserved during the subsequent stop of the vehicle at the stop sign since the engine is still not turning. In such a scenario, the computer knows from memory 34 that the fuel conserved during the coasting to the stop sign plus the fuel conserved during the time the vehicle is stopped at the stop sign, and taking into consideration a restart penalty, is greater than the fuel consumed if the engine is turned off at any other time in approaching the stop sign or while stopped at the stop sign. Moreover, the fuel conserved during the coasting to the stop sign plus the fuel conserved during the time the vehicle is stopped at the stop sign, is greater than if the engine where not turned off, but left to idle, even when the engine restart penalty is taken into consideration.

Thus, teachings of the present disclosure may incorporate a variety of data, each corresponding to a particular and specific geographic location of a vehicle, such as a geographic location of a vehicle. For instance, memory 34 may store data related to: one stop event or multiple “stop events” that may be used to determine the probability of a vehicle stop event or a vehicle coast event; length of time of a stop event that may be used to determine the median length of time of stop events in a particular zone, area or particular location; vehicle stop position or stop location of vehicle 10 that may be used to determine if an engine 12 can be turned off prior to vehicle 10 actually stopping; date of vehicle stop that may be used to arrive at more specific stopping information of vehicle 10; time of day of vehicle stop that may be used to arrive at more specific stopping information of vehicle 10; which turn signal indicator is activated (e.g. left or right) or if no turn signal indicator is activated, and at what geographic location such activation or non-activation occurs; and length of time of turn signal activation since left turns on average generally take longer to complete than right turns since crossing oncoming vehicles usually occurs. Thus, each time vehicle 10 stops, the length of the corresponding stop time at the corresponding GPS location, the calendar date (i.e. time, time block, the day of the week, month and year) of the vehicle stop, and geographic location will be stored in memory, such as memory 34. Geographic stop locations of vehicle 10 may include not only stop signs, but any conceivable location that a vehicle may stop, including but not limited to stop lights, also known as traffic lights, train crossings, also known as rail road crossings, on any road in any type of traffic (e.g. light or heavy), drive thru windows, etc.

As the idle-stop system of the present disclosure becomes more experienced, that is, as the memory 34 is filled with data representative of geographic locations of vehicle stops and duration of vehicle wait times at such geographic locations before moving again, as described above, fuel economy of vehicle 10 will improve and tail pipe emissions will be reduced per mile driven and for the life of vehicle 10, as compared to a vehicle without the benefit of teachings of the present disclosure. Continuing, teachings of the present disclosure instruct engine 12 when to stop turning and when not to stop turning when a vehicle makes a temporary stop at a location (e.g. traffic light, stop sign, railroad track, etc.) in route to a destination.

As examples, in accordance with idle-stop system teachings of the present disclosure, engine 12 may be instructed to stop turning (i.e. be turned off) as soon as a brake pedal 48 of vehicle 10 is contacted or pressed. When a brake pedal 48 is being pressed, GPS module 36 will know the changing location of vehicle 10, such as if vehicle 10 is approaching a location where vehicle 10 typically makes a complete stop, or at least coasts with engine 12 at idle. By stopping engine 12 as vehicle 10 is coming to a stop, as opposed to stopping engine 12 after coming to a stop, engine 12 will consume less fuel. That is, fuel is saved as vehicle 10 coasts toward a stop location without engine 12 operating compared to an equivalent engine that is not turned off. Moreover, additional fuel is saved since when vehicle 10 finally does stop as a result of application of brake pedal 48, engine 12 is already off. This is different from an engine in a vehicle that may be turned off after an elapse of a time period (e.g. 2-5 seconds) after the vehicle stops. In accordance with present teachings, electric power steering, as opposed to an engine-driven hydraulic system, will ensure that vehicle 10 maintains its steering system when engine 12 is turned off. Similarly, electric power brakes, or adequately sized vacuum reservoirs, will ensure that vehicle 10 maintains its braking system when engine 12 is turned off. If stopping vehicle 10 is no longer necessary as vehicle 10 approaches a potential geographic stop location, for whatever reason, a driver simply need touch or press accelerator pedal 50.

In another example of a data based intelligent engine idle stop system in accordance with present teachings, GPS module 36 in conjunction with GPS satellite 38 detects that vehicle 10 is a certain, predetermined distance away from an intersection and approaching the intersection. Besides an intersection, other geographic stop locations are known, as mentioned above. When a driver touches brake pedal 48 with his or her foot, GPS module 36, or other computer working in conjunction with GPS module 36, calculates based on previously saved or previously loaded data in memory, the probability of vehicle 10 stopping at the intersection. If the probability of a vehicle stopping at the intersection is high enough, the amount of time (i.e. time period in seconds or minutes) to the median stopping point using the current or real-time speed of vehicle 10 and the average deceleration are calculated. The acceleration and deceleration used in conjunction with the present teachings may be measured with an accelerometer, or they may be data based (e.g. read from stored memory). The GPS module 36 or computer performing the associated calculations may then add the calculated vehicle coast time with the median stop time and calculate if engine 12 will be more fuel efficient by leaving engine 12 on (i.e. running or turning) or by turning off engine 12. Thus, to illustrate the fuel savings for the scenario described in the above example, teachings of the present disclosure may calculate a four second coast to the intersection to the point where a vehicle may have to stop, and then a ten second engine restart fuel penalty. Thus, by turning off the engine at the beginning of the four second coast, such as when brake pedal 48 is contacted, and eliminating the time a vehicle may idle while stopped before turning off the engine, at least four seconds of fuel combustion by a vehicle engine is eliminated. While all vehicles have an engine start or restart fuel penalty, by eliminating engine fuel combustion before a vehicle comes to a complete stop at an anticipated stopping location and while a vehicle engine idles while stopped, fuel may be saved.

FIG. 5 is a graph of data confidence versus vehicle stops for a given vehicle. More specifically, each time the computer of GPS module 36 accesses memory 34 for the stored database of stop events, stop times or stop positions, the data will be analyzed prior to use. The analysis will determine if a predetermined number of samples of data exist to give enough statistical confidence to provide an accurate result. In other words, if a vehicle has stopped ten times out of the last ten approaches to a particular intersection, then the confidence level or data confidence, as measured upon the y-axis of FIG. 5 may be 100%. Still yet, a predetermined confidence number may be programmed into the computer by the user, for example, via buttons 30 or touch screen feature 32 of navigation control unit 26, through which the idle start-stop (“ISS”) system of the present disclosure may be accessed. Thus, the greater the number of vehicle stops at a particular geographical location, as depicted along the horizontal axis of FIG. 5, a greater confidence in usefulness or success of the teachings of the present disclosure may be achieved. A user of the teachings of the idle start-stop (“ISS”) system of the present disclosure may set his or her own confidence levels, such as in terms of percentages, to ensure that when a vehicle approaches an intersection, stop sign, etc. to ensure efficient control of engine 12 results in conservation of fuel. Any acceptable probability or any acceptable confidence level may be programmed in by the vehicle or component manufacturer or the vehicle driver.

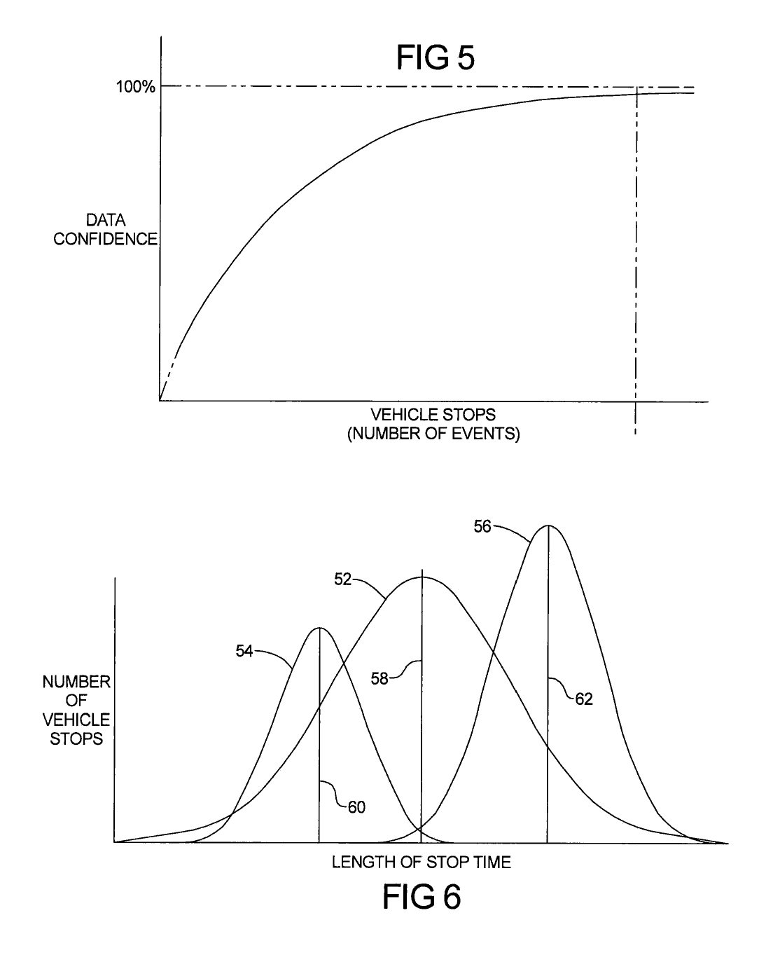

FIG. 6 is a graph of overlapping distributions of a number of stops for a given vehicle versus length of time stopped for such vehicle. More specifically, distribution 52 may be a plot of a quantity of length of stop times for a given vehicle at a prescribed stop location, such as a stop sign, for example, at a specific time of day (e.g. Noon) on a specific day of the week (e.g. Monday). Distribution 54 may be a plot of a quantity of length of stop times for the given vehicle at the prescribed stop location, such as the same stop sign as distribution 52 on the same day of the week (e.g. Monday) or a different day of the week (e.g. Sunday) at a different time of the day (e.g. 11 a.m.). Distribution 56 may be a plot of a quantity of length of stop times for the given vehicle at a prescribed stop location, such as the same stop sign as distribution 52 on the same day of the week (e.g. Monday) or a different day of the week (e.g. Tuesday) at a different time of the day (e.g. 1 PM). FIG. 6 represents one potential solution to a situation such that if not enough specific data points for a distribution, such as distribution 52, the computer, such as a computer of GPS module 36, will permit a broadening of the data filter to permit, for example, older data and data that may be the same location but not the same time of day, etc. Thus, if not enough data points exist from distribution 52, then the data points of distribution 54 may be combined with those of distribution 52 to permit use of the ISS system. Distributions 52, 54, 56 each have a specific mean length of stop time. For instance distribution 52 has a mean length of stop time 58, distribution 54 has a mean length of stop time 60 and distribution 56 has a mean length of stop time 62. Thus, combining data points of distributions 52, 54, 56 may permit use of ISS system that otherwise is not permissible; however, prior to proceeding with such a combination of distributions 52, 54, for example, the computer will determine if enough data points are available to satisfy a predetermined statistical confidence level, as explained above in conjunction with FIG. 5.

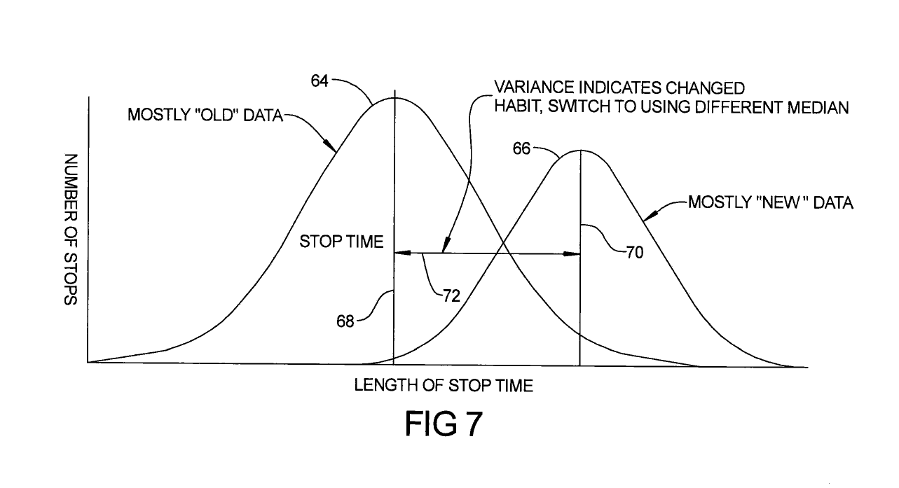

FIG. 7 is a graph of different distributions of number of stops for a given vehicle or vehicles versus length of time stopped for such vehicle. If the computer detects a variance in a specified number of new data points, such as between distribution 64 and distribution 66, and more specifically, between mean 68 of distribution 64 and mean 70 of distribution 66, the computer may determine that some event has happened that rapidly changed or is changing the mean of a given distribution, such as distribution 64. The mean of distribution 64 is mean 68, which is the middle or peak of the distribution 64. Such a change in driving behavior and corresponding recorded data may be experienced when a driver starts driving to work one hour later than a previously recorded distribution. Thus, distribution 64 may represent a collection of stop times with a mean stopping time of 7 a.m. at a stop sign, represented by mean 68, while distribution 66 may represent a collection of stop times with a mean stopping time of 8 a.m. at the same stop sign, represented by mean 70. Line 72 represents a shift or variance between mean 68 and mean 70. Thus, instead of the computer slowly adapting to the changing stop event, the computer may more rapidly adapt by adapting mean 70 as the length of the stop event at a prescribed stop location. Thus, as represented by FIG. 7, mean length of stop time 70 of distribution 66 may be less than mean length of stop time 68 of distribution 64. Length of stop time may thus impact operation of ISS system.

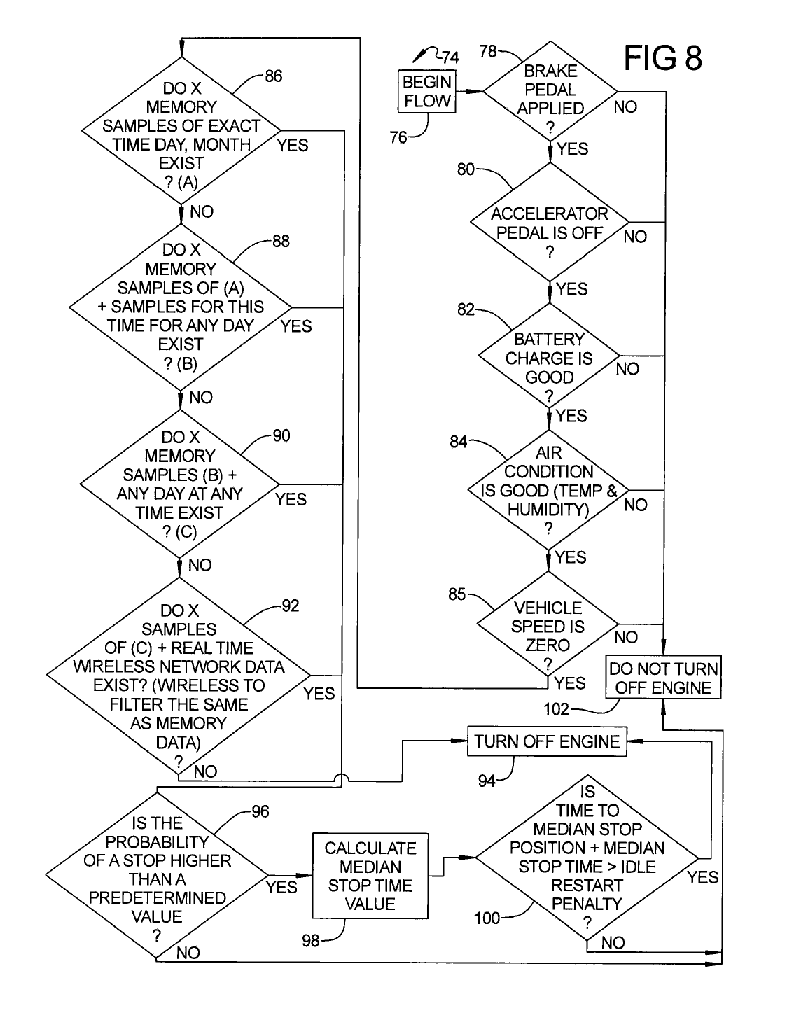

FIG. 8 depicts a flowchart 74 of logic of an idle start-stop system according to teachings of the present disclosure. At block 76 the logic begins with engine 12 running, and proceeds to step 78 where an inquiry is made if brake pedal 48 is applied. If brake pedal 48 is applied, logic of flowchart 74 proceeds to step 80 where an inquiry is made if accelerator pedal 50 is applied. If accelerator pedal 50 is applied, logic of flowchart 74 proceeds to step 82 where an inquiry is made if on board battery or battery pack 18 is adequately charged to restart the vehicle. If on board battery pack 18 is adequately charged, logic of flowchart 74 proceeds to step 84 where an inquiry is made if the temperature and humidity content of air blowing from air conditioning vent 31 is within predetermined satisfactory ranges. If the temperature and humidity content of air blowing from air conditioning vent 31 is within predetermined satisfactory ranges, logic of flowchart 74 proceeds to step 85, where an inquiry is made if the speed of vehicle 10 is zero. Step 85 may be an optional step in the logic of flowchart 74. The logic of flowchart 74 proceeds to step 86 if the vehicle speed is zero. However, if any of the answers or results to the inquiries of steps 78, 80, 82, 84 and 85 are “no” or are “unsatisfactory,” then the logic proceeds to step 102 and engine 12 of vehicle 10 continues to turn or run. That is, ECM 14 sends no command to engine 12 that would cause engine 12 to turn off.

At step 86, logic of flowchart 74 inquires if memory 34 presently holds a data sample of a precise time (e.g. a.m. and/or p.m.) for a precise day of the week (e.g. Monday, Tuesday, Wednesday, Thursday, Friday, Saturday, Sunday), for a precise month of the year (e.g. January, February, March, April, May, June, July, August, September, October, November, December) for a specific geographic location pertaining to a geographic location identified by GPS module 36 in conjunction with GPS satellite 38. Step 86 may further inquire if a specific quantity of sets of data (i.e. a set being all three of a time of day, a day of the week and a month of the year) exist for a specific geographic location. If the result of the inquiry at step 86 is “no,” then the logic proceeds to step 88.

At step 88, the logic inquires if memory 34 presently holds a data sample of a precise time (e.g. a.m. and/or p.m.), for any day of the week (e.g. Monday, Tuesday, Wednesday, Thursday, Friday, Saturday, Sunday) for a precise month of the year (e.g. January, February, March, April, May, June, July, August, September, October, November, December) for the specific geographic location pertaining to step 86. Step 88 may further inquire if a specific quantity of sets of data (i.e. a set being all three of a time of day, a month of the year, but for any day of the week) exists for one or more specific geographic locations. If the result of the inquiry at step 88 is “no,” then the logic proceeds to step 90. At step 90, the logic inquires if memory 34 presently holds a data sample of any time (e.g. a.m. and/or p.m.), for any day of the week (e.g. Monday, Tuesday, Wednesday, Thursday, Friday, Saturday, Sunday) for any month of the year (e.g. January, February, March, April, May, June, July, August, September, October, November, December) for the specific geographic location pertaining to step 86. Step 90 may further inquire if a specific quantity of sets of data (i.e. a set being all three of a time of day, a month of the year, and day of the week) exists for one or more specific geographic locations. If the result of the inquiry at step 90 is “no,” then the logic proceeds to step 92.

At step 92, the logic further inquires if a specific quantity of sets of data (i.e. a set being all three of a time of day, a month of the year, and day of the week) exists for a specific geographic location. Moreover, the logic inquires if real time wireless network data exists. That is, GPS module 36 may communicate wirelessly to a database 39 (FIG. 2) via GPS satellite 38 to inquire if any vehicles have uploaded data for a particular geographic location pertinent to a potential, upcoming stop location of vehicle 10. Thus, data used by vehicle 10 in controlling a stopping of engine 12, does not have to be accumulated by vehicle 10 alone, but rather information may be shared amongst multiple vehicles and be uploaded and downloaded from central database 39. Wireless data may be “filtered” in the same manner as data compiled by vehicle 10 and resident in memory 34. That is, filtering consistent with steps 86, 88 and 90 may take place. If the result of the inquiry at step 92 is “no,” then the logic proceeds to step 94, where vehicle engine 10 is turned off.

If the result of any of the inquiries of steps 86, 88, 90, 92 is “yes,” then the logic proceeds to step 96, which inquires whether the probability of a stop is higher than a predetermined value. If the result of such an inquiry is “no,” then the logic proceeds to step 102 where the logic instructs ECM 14 to not stop engine 12. However, if the result of the inquiry at step 96 is “yes” then the logic proceeds to step 98 where the logic instructs a computer, resident in GPS module 36 or ECM 14, for example, to calculate a median stop time value. The logic then proceeds to step 100, which inquires if a sum of a time to median stop position plus median stop time is greater than the idle restart penalty. If the answer to such inquiry of step 100 is “yes,” then the logic proceed to step 94 where ECM 14 may instruct engine 12 to be turned off; however, if the answer to such inquiry of step 100 is “no,” then the logic proceed to step 102 where ECM 14 may instruct engine 12 not to be turned off. Upon reaching either step 94 or 102, logic of flowchart may then begin again at step 76.

Presented in slightly different words, a method of controlling internal combustion engine 12 of vehicle 10 may first entail turning on the internal combustion engine 12. Next, and with reference to flowchart 74, determining that a brake pedal 48 of vehicle 10 is applied (step 78), determining that accelerator pedal 50 of vehicle 10 is off or not applied (step 80), determining that the battery 18 of vehicle 10 are adequately charged (step 82), and determining that an air temperature and a humidity level of air coming from an air conditioning unit is within a predetermined range (step 84), the logic may then proceed to step 86. Step 86 involves inquiring whether a first predetermined quantity of data samples exists in memory 34 and more specifically, whether the first predetermined quantity of data samples corresponds to a specific time of day, of a specific day of the week, of a specific month of the year, for a specific GPS location. That is, when vehicle 10 approaches a potential stop location, such as may be known from stored data within memory 34, or when vehicle 10 actually stops at a location, the specific time of day (e.g. 2 o'clock), the specific day of the week (e.g. Monday), the specific month (e.g. January) of the year (e.g. 2010), and specific GPS location (e.g. latitude and longitude, street address, cross-streets intersection, etc.) corresponding to the vehicle stop are recorded into memory 34.

If a predetermined quantity of memory samples (i.e. a predetermined preferred number of stops) in accordance with step 86, do not exist, the method of control proceeds to step 88 where a broadening of criteria occurs. That is, the logic proceeds to inquiring whether a predetermined quantity of data samples (e.g. vehicle stops) exists in memory for the specific time of day of the present vehicle stop, but for any day of the week (e.g. Tuesday, Wednesday, etc. as opposed to Monday) for the specific GPS location of the vehicle stop. If the predetermined quantity (e.g. 10 vehicle stops) is not satisfied at step 86 and step 88, which means that ten vehicle stops are not within memory 34 for a prescribed GPS location, the logic then proceeds to step 90 by inquiring whether a predetermined quantity of data samples exists for any single, specific time of day for any day of the week for the specific GPS location of the stop or anticipated stop of vehicle 10. Still yet, if the requirements or inquiries made at steps 86, 88 and 90 are not met, the logic proceeds to step 92 where the method of controlling an internal combustion engine 12 inquires whether a predetermined quantity of data samples exists as downloadable data from a real time wireless network. That is, instead of the inquiries of steps 86, 88 and 90 being met by data resident in memory 34 of vehicle 10, that is as on-board data of vehicle stops, database 39 may be contacted via satellite 38, or alternatively through other wireless means such as cell phone towers, to see if any of the inquiries of steps 86, 88 and 90 may be satisfied. That is, non on-board data may be used. Such non on-board data may be stored by other vehicles and correspond to particular, specific GPS locations.

If the result of inquiries made at steps 86, 88, 90 and 92 is “no,” meaning that data does not exist, then the engine 12 is turned off, as is noted at step 94. However, if a result of any of the inquiries made at steps 86, 88, 90 and 92 is “yes,” meaning that data satisfying the respective inquiry does exist in memory 34, the logic proceeds to step 96 where an inquiry is made as to whether a probability of a physical stop of the vehicle is greater than a predetermined probability, which may be set by a vehicle user or vehicle manufacturer. If the result of the inquiry made at step 96 is “yes,” then the logic proceeds to step 98 where calculating a median stop time value is performed. A median stop time value is that median period of time that a vehicle needs to stop at a known stopping location, which may be calculated from times of known stops and stored in memory 34. Upon such calculation at step 98, the logic proceeds to step 100 where the logic inquires whether a time to a median stop position plus a median stop time is greater than the idle restart penalty.

More specifically, regarding step 100, a median stop time, as explained in conjunction with step 98, may be combined with a time to a median stop position. That is, time to a median stop position may be that time as measured from when a vehicle begins to decelerate or slow down until such vehicle actually stops at the known stopping location. The known stopping location may be a median stopping location. In one scenario of step 100, a vehicle GPS will know a stop location or position of vehicle 10 from memory 34. In addition to known GPS coordinates of a stop location, also known are a speed of vehicle 10 and a position to vehicle 10, from which a distance from a present location of vehicle 10 to the known stop position may be calculated. Thus, a time to median stop position may be calculated. The on-board computer may then add the median stop time, that is, how long the vehicle will be stopped on average, to the time to the median stop position. If the result at the inquiry at step 100 is “yes,” then the engine is turned off at step 94. However, if the result of the logic at step 100 is “no,” then the engine is not turned off, as reflected in step 102.

The foregoing description of the embodiments has been provided for purposes of illustration and description. It is not intended to be exhaustive or to limit the disclosure. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. Moreover, the method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method of controlling an internal combustion engine of a vehicle, the method comprising:
turning on the internal combustion engine; and
inquiring whether a first predetermined quantity of data samples exists in memory and further inquiring whether the first predetermined quantity of data samples corresponds to a specific time of day, of a specific day of the week, of a specific month of the year, for a specific GPS location.

2. The method of controlling an internal combustion engine according to claim 1, further comprising:
inquiring whether a second predetermined quantity of data samples exists in memory for the specific time of any day of the week for the specific GPS location.

3. The method of controlling an internal combustion engine according to claim 2, further comprising:
inquiring whether a third predetermined quantity of data samples exists for any single, specific time of day for any day of the week for the specific GPS location.

4. The method of controlling an internal combustion engine according to claim 3, further comprising:
inquiring whether a fourth predetermined quantity of data samples exists as downloadable data from a real time wireless network.

5. The method of controlling an internal combustion engine according to claim 4, further comprising turning off the internal combustion engine.

6. The method of controlling an internal combustion engine according to claim 1, further comprising:
inquiring if a probability of a physical stop of the vehicle is greater than a predetermined probability;
calculating a median stop time value; and
inquiring whether a time to a median stop position plus a median stop time is greater than the idle restart penalty.

7. The method of controlling an internal combustion engine according to claim 2, further comprising
inquiring if a probability of a physical stop of the vehicle is greater than a predetermined probability;
calculating a median stop time value; and
inquiring whether a time to a median stop position plus a median stop time is greater than the idle restart penalty.

8. The method of controlling an internal combustion engine according to claim 3, further comprising
inquiring if a probability of a physical stop of the vehicle is greater than a predetermined probability;
calculating a median stop time value; and
inquiring whether a time to a median stop position plus a median stop time is greater than the idle restart penalty.

9. The method of controlling an internal combustion engine according to claim 4, further comprising
inquiring if a probability of a physical stop of the vehicle is greater than a predetermined probability;
calculating a median stop time value; and
inquiring whether a time to a median stop position plus a median stop time is greater than the idle restart penalty.

10. The method of controlling an internal combustion engine according to claim 1, further comprising:
inquiring if a probability of a physical stop of the vehicle is greater than a predetermined probability; and
not turning off the internal combustion engine.

11. The method of controlling an internal combustion engine according to claim 4, further comprising:
inquiring if a probability of a physical stop of the vehicle is greater than a predetermined probability; and
not turning off the internal combustion engine.

12. A method of controlling an internal combustion engine of a vehicle, the method comprising:
turning on the internal combustion engine;
determining that a brake pedal of the vehicle is applied;
determining that an accelerator pedal of the vehicle is not applied;
determining that a battery of the vehicle is adequately charged;
determining that an air temperature of air coming from an air conditioning unit is within a predetermined range;
determining that a humidity level of air coming from an air conditioning unit is within a predetermined range; and
inquiring whether a first predetermined quantity of data samples exists in memory and further inquiring whether the first predetermined quantity of data samples corresponds to a specific time of day, of a specific day of the week, of a specific month of the year, for a specific GPS location.

13. The method of controlling an internal combustion engine according to claim 12, further comprising:
inquiring whether a second predetermined quantity of data samples exists in memory for the specific time of any day of the week for the specific GPS location.

14. The method of controlling an internal combustion engine according to claim 13, further comprising:
inquiring whether a third predetermined quantity of data samples exists for any single, specific time of day for any day of the week for the specific GPS location.

15. The method of controlling an internal combustion engine according to claim 14, further comprising:
inquiring whether a fourth predetermined quantity of data samples exists as downloadable data from a real time wireless network.

16. The method of controlling an internal combustion engine according to claim 15, further comprising turning off the internal combustion engine.

17. The method of controlling an internal combustion engine according to claim 12, further comprising:
inquiring if a probability of a physical stop of the vehicle is greater than a predetermined probability;
calculating a median stop time value; and
inquiring whether a time to a median stop position plus a median stop time is greater than the idle restart penalty.

18. The method of controlling an internal combustion engine according to claim 13, further comprising
inquiring if a probability of a physical stop of the vehicle is greater than a predetermined probability;
calculating a median stop time value; and
inquiring whether a time to a median stop position plus a median stop time is greater than the idle restart penalty.

19. The method of controlling an internal combustion engine according to claim 14, further comprising
inquiring if a probability of a physical stop of the vehicle is greater than a predetermined probability;
calculating a median stop time value; and
inquiring whether a time to a median stop position plus a median stop time is greater than the idle restart penalty.

20. The method of controlling an internal combustion engine according to claim 15, further comprising
inquiring if a probability of a physical stop of the vehicle is greater than a predetermined probability;
calculating a median stop time value; and
inquiring whether a time to a median stop position plus a median stop time is greater than the idle restart penalty.
